(19) United States
(12) Patent Application Publication
(10) Pub. No.: US 2012/0082541 A1
(43) Pub. Date: Apr. 5, 2012

(54) GAS TURBINE ENGINE CASING

(76) Inventors: Enzo Macchia, Kleinburg (CA); Barry Barnett, Markham (CA); Andreas Eleftheriou, Woodbridge (CA); Tom McDonough, Barrie (CA); George Guglielmin, Toronto (CA); Joe Lanzino, Orangeville (CA)

(21) Appl. No.: 13/189,100

(22) Filed: Jul. 22, 2011

Related U.S. Application Data
(60) Provisional application No. 61/388,407, filed on Sep. 30, 2010.

(51) Int. Cl. F01D 25/24; B23P 17/00

(52) U.S. Cl. 415/200; 29/888

(57) ABSTRACT

An engine casing for a gas turbine engine, such as, but not limited to, a gas turbine engine fan case, is disclosed which includes an annular case shell formed of a substrate material that is at least partially coated by a nanocrystalline metal coating. A method of manufacturing such an engine casing is also provided. The present engine casing provides improved containment capability in the event of a blade release or other failure during operation of the engine.

### CROSS-REFERENCE TO RELATED APPLICATIONS

The present application claims priority on U.S. Provisional Patent Application No. 61/388,407 filed Sep. 30, 2010, the entire contents of which is incorporated herein by reference.

TECHNICAL FIELD

The application relates generally to casings for gas turbine engines, and in one aspect to containment structures therefor.

### BACKGROUND

The typical aircraft turbofan gas turbine engine includes a fan case encircling the fan blades or other rotating components. In the event of a failure during operation of the engine, portions of the fan blade may become separated from the hub. Fan casings are therefore designed to contain any such fragmented pieces, released from the rotating fan hub, within the surrounding casing. However, a metallic case thick enough to perform this task would often be prohibitively heavy. Therefore, the fan case often includes a non-metallic containment structure, composed for example of Kevlar (a trademark of E.I. Dupont de Nemours & Company) or other ballistic fabric wrapped around the case. Containment systems which include fabric are more weight efficient than metallic containment cases, but nonetheless add considerable weight to the engine. The durability of the fabric can also be an issue. Elsewhere in the engine, such as surrounding compressor blades, weight-efficient containment is also an issue. Thus, there is room for improvement in the design of cases surrounding gas turbine engines, such as fan cases, and in gas turbine engine containment generally.

### SUMMARY

In accordance with one aspect of the present application, there is provided an engine casing for a gas turbine engine, comprising an annular case shell formed of a substrate material, and a nanocrystalline metal coating provided on at least a portion of an inner or outer surface of the annular case shell and extending therearound a circumferential extent.

There is also provided, in accordance with another aspect, a method of manufacturing an engine casing for a gas turbine engine comprising the steps of: providing an annular case shell formed of a substrate material; and applying a nanocrystalline metal coating over at least a portion of the annular case shell.

There is further provided, in accordance with yet another aspect, a method of improving containment capability of a gas turbine engine case comprising applying a nanocrystalline metal coating over at least a portion of a substrate material of an annular case shell, said portion including at least a containment zone surrounding a rotatable bladed rotor of the gas turbine engine.

### DESCRIPTION OF THE DRAWINGS

Reference is now made to the accompanying figures in which:

FIG. 1 is a schematic cross-sectional view of a gas turbine engine;

FIG. 2 is a cross-sectional view of a portion of the fan case of the gas turbine engine of FIG. 1;

FIGS. 3 and 3a are cross-sectional views of another portion of the fan case of the gas turbine engine of FIG. 1, with FIG. 3a being an enlargement of the indicated portion of FIG. 3;

FIG. 4 is a cross-sectional view of another portion of the fan case of the gas turbine engine of FIG. 1;

FIG. 5 is a cross-sectional vie of another portion of the fan case of the gas turbine engine of FIG. 1;

FIG. 5a is an enlarged perspective view of a structure of the portion of the fan case of FIG. 5, and FIG. 5b is an enlarged cross-sectional view of the portion of the fan case of FIG. 5; and

FIG. 6 is a cross-sectional view of another portion of fan case of the gas turbine engine of FIG. 1;

FIG. 6a is an enlarged perspective view of a structure of the portion of the fan case of FIG. 6; and

FIG. 7 is a transverse cross-sectional view of another portion of a fan case of the gas turbine engine of FIG. 1; and

FIG. 7a is an enlarged cross-sectional view of a joint between sections of the portion of the fan case shown in FIG. 7.

### DETAILED DESCRIPTION

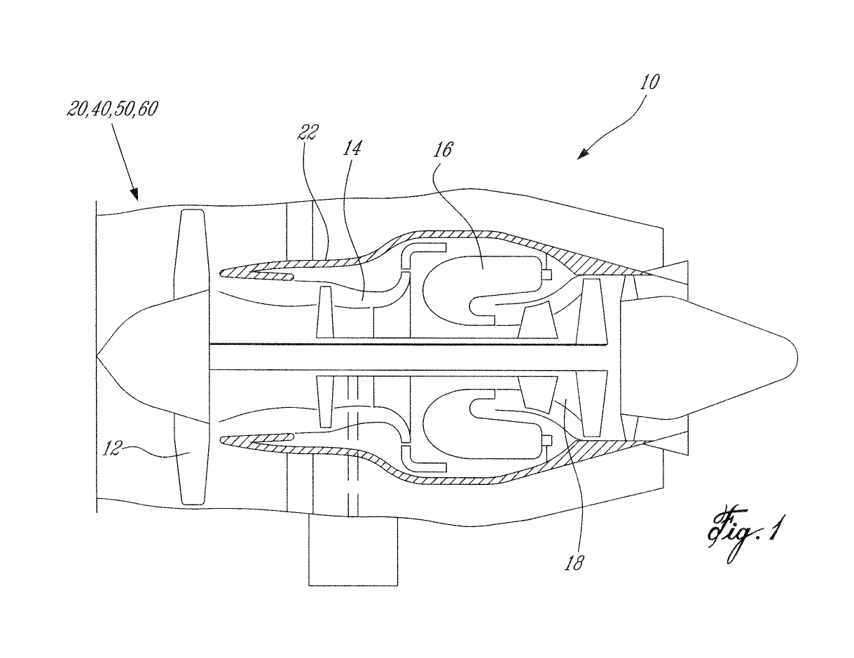

FIG. 1 illustrates a gas turbine engine 10, generally comprising in serial flow communication, a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases. The engine has a case which includes a fan case 20, 40, 50, 60 surrounding the fan blades and a compressor case 22 surrounding the compressor. These cases, inter alia, provide for blade containment in the unlikely event of a blade release.

Referring to FIG. 2, a portion of one example of the fan case 20 is shown, and the relative position of the fan 12 is shown in broken lines for reference. In this example, the fan case 20 comprises an annular metallic shell 21 and a thin layer of nanocrystalline coating 24 (“nano coating”) provided over at least a blade containment zone 26 of the fan case 20. The nano coating 24 is plated onto the metallic shell 21 in this example, but may be provided thereon in any suitable manner. The nano coat layer 24 can be applied to either the inner or outer surfaces of the metallic shell 21, or both. The metallic shell is stainless steel in this example, but may be any suitable metal, such as aluminum, titanium and Armco (trademark of AK Steel Corporation). The nano coating 24 may be a Nanovate (trademark of Integran Technologies) pure nickel (Ni), pure cobalt (Co), or cobalt-phosphorous (CoP) coating, which tend to exhibit significant yield strength, ductility and ultimate tensile strength (UTS) improvement over traditional steels or other metals at comparable densities. This is especially true at high strain rates which are typically observed during blade containment events. The resulting fan case 20 may be able to absorb more impact energy, and/or may be lighter, and/or may be cheaper to make, when compared to conventional fan cases. If desired, the entire fan case 20 may be encapsulated by the nano coating layer 24, i.e. the containment zone 26 may extend along a full length of the fan case 20, or at least a majority thereof. Alternately, any number of other areas of the fan case 20 may be coated by the nano coating 24, in addition to the containment zone 26. The coating may be applied in addition to other mechanical containment feature(s) already provided on the case, such as radially-extending circumferential ribs or any other mechanical containment feature provided on the case.

The nanocrystalline coating 24 applied to the annular metallic shell 21 of the fan case 20 may be a pure metal selected from the group consisting of: Ag, Al, Au, Co, Cu, Cr, Sn, Fe, Mo, Ni, Pt, Ti, W, Zn and Zr, and is purposely pure (i.e. not alloyed with other elements) to obtain specific material properties sought herein. It is to be understood that the term “pure” is intended to include a metal comprising trace elements of other components. As such, in a particular embodiment, the pure Nickel coating includes trace elements such as, but not limited to: C=200 parts per million (ppm), S<500 ppm. Co=10 ppm, O=100 ppm.

The nanocrystalline metal coating 24 has a fine grain size, which provides improved structural properties of the fan case 20. The nanocrystalline metal coating is a fine-grained metal, having an average grain size at least in the range of between 1 nm and 5000 nm. In a particular embodiment, the nanocrystalline metal coating has an average grain size of between about 10 nm and about 500 nm. More preferably, in another embodiment the nanocrystalline metal coating has an average grain size of between 10 nm and 50 nm, and more preferably still an average grain size of between 10 nm and 15 nm. The manipulation of the metal grain size, when processed according to the methods described below, produces the desired mechanical properties for the present gas turbine engine case. In a particular embodiment, the pure metal of the nanocrystalline metal coating 24 is nickel (Ni) or cobalt (Co), although other metals can alternately be used, such as for example copper (Cu) or one of the above-mentioned metals.

The nanocrystalline metal coating 24 may be applied as a single layer onto the annular shell 21 of the case 20. However, it is to be understood that multiple layers of the nanocrystalline metal coating may also be applied, as necessary.

The nanocrystalline coating 24 forms an outer layer which acts structurally to stiffen and strengthen the substrate material of the fan case 20. Due to the nanocrystalline grain size, the nano-scale coating provides for improved structural properties of the fan case. In order to provide further protection to a substrate metal which may usually be susceptible to corrosion, such as aluminum, the case 20 may be fully encapsulated by the nano coating 24, such that the metal substrate of the annular metallic casing 21 is no longer exposed to air or the elements.

The nanocrystalline coating 24 tends to lower the stress and deflection in the substrate material when a load is applied. As the thickness of the nano coating increases, the stress and deflection of the substrate may be reduced. Conversely, the stiffness of the substrate material may have a significant impact on the overall deflection and stress levels in the nano coating. The designer may therefore adjust (among other things) the relative thickness and strengths of these two components to provide the desired properties. The thickness of the layer of nanocrystalline metal coating 24 may range from about 0.0005 inch to about 0.125 inch, however in a particular embodiment the nanocrystalline metal coating 24 has a thickness of between 0.001 and 0.008 inches. In another more particular embodiment, the nanocrystalline metal coating has a thickness of about 0.005 inches. The thickness of the nanocrystalline coating may also be tuned (i.e. modified in specific regions thereof, as required) to provide a structurally optimum engine casing. Additionally, the thickness of the nanocrystalline coating 24 may not have a constant thickness throughout the engine case, and as such the nano coating may be provided in thicker and thinner regions, as may be desired by the designer to provide more or less reinforcement to given zones of the engine casing.

In the above example, the nano coating 24 is applied through a plating process in a bath to apply a fine-grained metallic coating to the article, however any suitable plating or other coating process can be used, such as for instance the plating processes described in U.S. Pat. No. 5,352,266 issued Oct. 4, 1994; U.S. Pat. No. 5,433,797 issued Jul. 18, 1995; U.S. Pat. No. 7.425,255 issued Sep. 16, 2008; U.S. Pat. No. 7,387,578 issued Jun. 17, 2008; U.S. Pat. No. 7,354,354 issued Apr. 8, 2008; U.S. Pat. No. 7,591,745 issued Sep. 22, 2009; U.S. Pat. No. 7,387,587 B2 issued Jun. 17, 2008 and U.S. Pat. No. 7,320,832 issued Jan. 22, 2008, the entire contents of each of which are incorporated herein by reference. Any suitable number of plating layers (including one or multiple layers of different grain size, and/or a larger layer having graded average grain size and/or graded composition within the layer) may be provided.

The nanocrystalline metal(s) material used is/are variously described in the patents incorporated by reference above, namely U.S. Pat. No. 5,352,266, U.S. Pat. No. 5,433,797, U.S. Pat. No. 7,425,255, U.S. Pat. No. 7,387,578, U.S. Pat. No. 7,354,354, U.S. Pat. No. 7,591,745, U.S. Pat. No. 7,387,587, and U.S. Pat. No. 7,320,832, the entire content of each of which is incorporated herein by reference.

The nanocrystalline coating 24 may be a nanocrystalline metal applied directly to the substrate of the metallic shell 21 of the fan case 20. If required or desired, a non-conductive substrate surface, such as fiber reinforced polymer composite, can be rendered conductive, e.g. by coating the surface with a thin layer of silver, nickel, or copper or by applying a conductive epoxy or polymeric adhesive materials prior to applying the coating layer(s). See U.S. Pat. No. 7,591,745, for example, which is incorporated herein by reference. Additionally, the substrate may be rendered better suitable for electroplating by applying such a thin layer of conductive material, such as by electroless deposition, physical or chemical vapour deposition, etc.

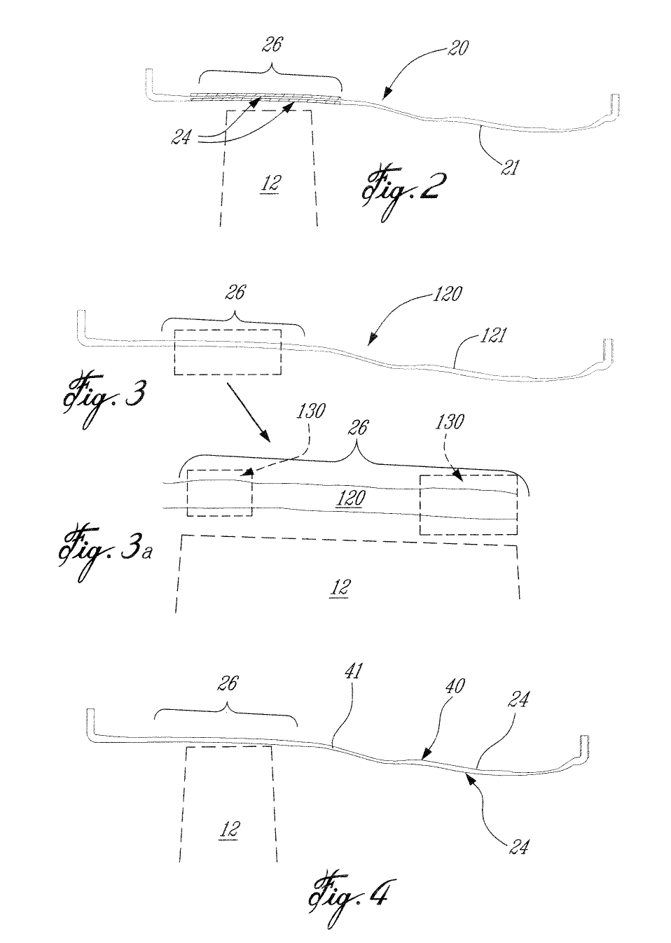

Referring to FIGS. 3 and 3a, a portion of another example of a fan case 120 is shown, and the relative position of the fan 12 is shown in broken lines for reference. In this example, the fan case 120 comprises an annular metallic shell 121 and a plurality of thin nanocrystalline metal coated “ribs” 130 located in the containment zone 26 and which extend circumferentially about the annular fan case 120. In this example, a casing rib 130 is provided roughly in correspondence with the leading and trailing edges of the fan blade 12. The nanocrystalline metal coated rib 130 is plated onto the metallic shell 121 in this example, but may be provided thereon in any suitable manner. Nano coating materials such as described above may be used. Any suitable “rib” shape may be coated onto the fan case 120, and the rib(s) 130 may be applied to either the inner or outer shell surface, or both. In the example of FIGS. 3-3a, the ribs 130 extend circumferentially uninterruptedly around the 120 case. Such a nano coating “rib” design of the fan case 120 may improve containment capacity, and/or may permit the thickness of the annular metal shell 121 to be reduced in regions of the casing outside each of the nano-coated ribs 130, and outside the identified fan blade containment zone 26. This approach may also permit improved containment on cases made from flow forming, sheet metal cases or other manufacturing processes which may limit the addition of geometrical strengthening features.

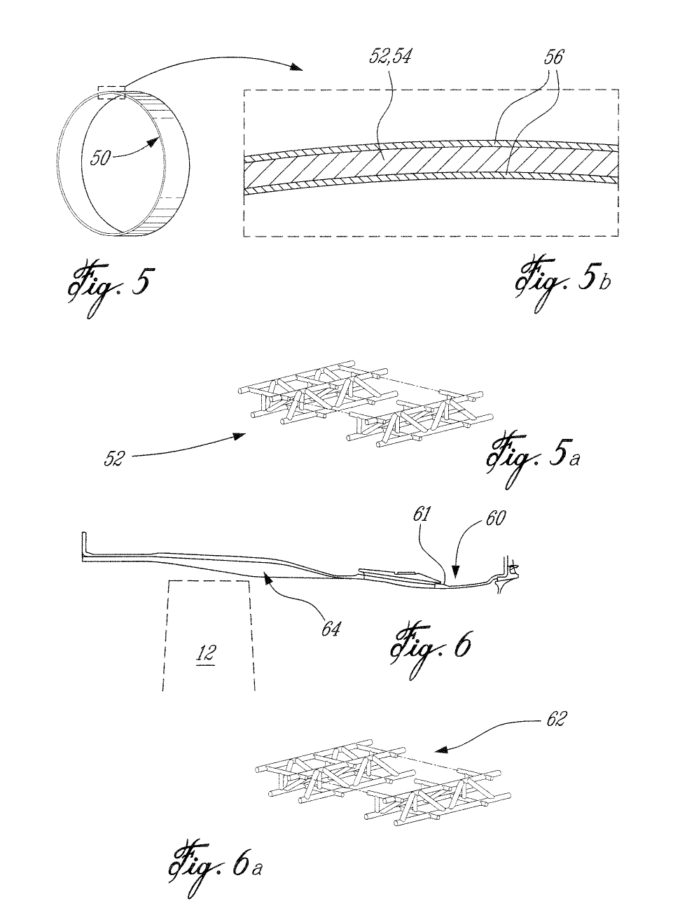

Referring to FIG. 4, a portion of another example of a fan case 40 is shown, and the relative position of the fan 12 is shown in broken lines for reference. In this example, the fan case 40 comprises an annular non-metallic shell 41 and a thin layer(s) of nanocrystalline coating 24 provided over the entire fan case 40, such as to encapsulate the non-metallic shell 41. A local thickening, or multiple layers, of the coating 24 may be provided in blade containment zone 26 of the fan case 40. The nano coating 24 described above may be plated onto the non-metallic shell in this example, but may be provided thereon in any suitable manner. The non-metallic shell 41 may be composed of a substrate material that is a polymer such as a conventional Kevlar wrap in this example, but may be any suitable non-metallic substrate, such as a carbon-fibre composite, a carbon fibre weave, a short fibre encased in epoxy, or other composite, or a polymer such as nylon (polyamide), polyether ether ketone (PEEK), and Vespel (polimide). Some polymers may permit manufacturing using near net-shape methods, such as injection moulding, which may further reduce manufacturing costs as compared to machining metal cases. The nanocrystalline coating may be a Nanovate (trademark of Integran Technologies) as described above. The resulting fan case 40 may be able, to absorb more impact energy, and/or may be lighter, and/or may be cheaper to make. when compared to conventional all-metal fan cases. The nanocrystalline metal coating 24 may be applied in addition to mechanical containment feature(s) already provided on the case, such as radially-extending circumferential ribs or any other mechanical containment feature provided on the case. In another example, the non-metallic shell may be coated only on one side, such as the inner side of the shell 40. The polymer core 41 of the fan case 40 may be manufactured by any suitable method, such as injection moulding, blow molding, forming or pressing. Accordingly, the polymer core 41 may be of a relatively low-grade polymer, which makes the molding and other fabrication process thereof relatively time and cost efficient. In a particular embodiment, the polymer substrate for the case core 41 is a polyether ether ketone (PEEK), such as 450CA30 or 90HMF40, or a Nylon polymer (i.e. a polyamide), such as Durethan™ or 70G40. Examples of relatively high tensile strength polymers which may also be used for the non-metallic core of the case 40 are Vespel (a polyimide), Torlon and Ultem etc.

While the nanocrystalline metal coating 24 may be applied directly to the annular polymer substrate or core shell 41 of the fan case 40, in an alternate embodiment an intermediate bond coat may be first deposited onto the non-metallic substrate of the annular core or shell 41 before the nanocrystalline metallic top coat 24 is applied thereto. This intermediate bond coat may improve bond strength and structural performance of the nanocrystalline metal coating 24 that otherwise may not bond well when coated directly to the polymer substrate of the shell 41. In another embodiment, described for example in more detail in U.S. Pat. No. 7,591,745 which is incorporated herein by reference, a layer of conductive material may be employed between the polymer substrate of the shell 41 and the nanocrystalline metal coating 24 to improve adhesion there between and therefore improve the coating process.

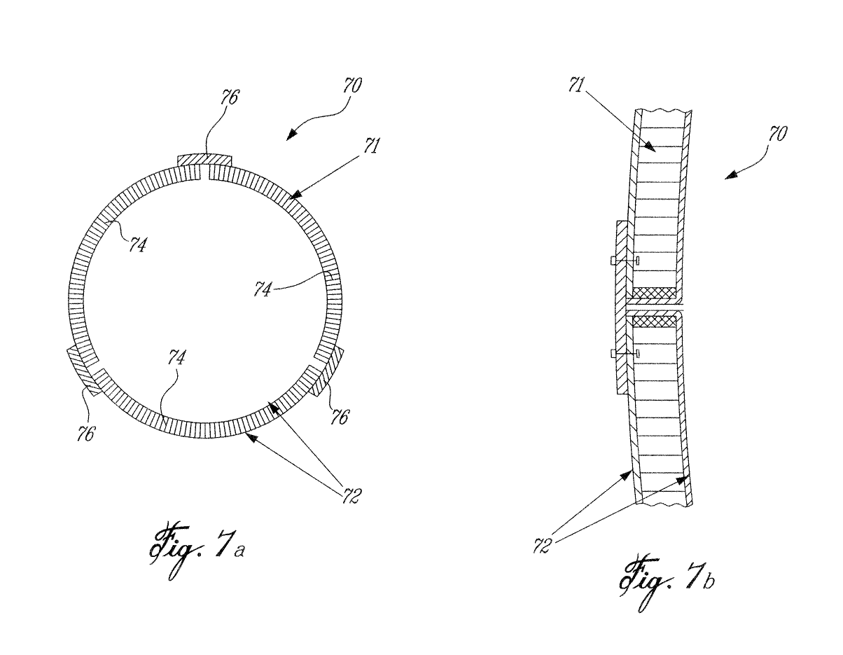

Referring to FIG. 5, a portion of another example of a fan case 50 is shown. In this example, the fan case 50 comprises an annular shell made of core formed by a polymer micro-truss 52 material (see FIG. 5a) that is coated with a thin layer of nanocrystalline coating 54, and wherein this core is then sandwiched between two layers of outer sheet metal 56. The nano truss 52 is manufactured by coating a conventional polymer truss in nanocrystalline metal using a plating process or other suitable process to apply the nano coating to the truss structure. Nano coating materials such as Nanovate (trademark of Integran Technologies) and those described above are suitable. A low-density nanocrystalline material may be created in any suitable manner, such as by using rapid prototyping equipment to form an acrylic photopolymer micro-truss. The truss structure 52 of the fan case 50 can alternately be replaced with honeycomb or foam as will be described below with respect to FIGS. 7-7a, or other structure.

In this alternate example, shown in FIGS. 7-7a, the fan case 70 comprises an annular shell, which may either be circumferentially continuous such as the fan cases described above or may be composed of several part-circumference sections 74 as shown in FIG. 7 which are attached together by joints 76. The annular shell of the fan case 70 is composed of a core 71 formed of honeycomb or foam that is “sandwiched” between two outer layers 72. The outer layers 72 disposed on either side of the honeycomb or foam core 71 may be sheet metal layers that have been coated with a nanocrystalline metal. Alternately, the honeycomb or foam 71 may be directly coated (not depicted) by nanocrystalline metal to form the outer layers 72. Still alternately, a single sandwich layer is provided on one side of the honeycomb or foam core 71 (inner or outer side) and the honeycomb/foam core 71 is also directly coated (not depicted). Other variations are also possible. The use of nanocrystalline metal coating on the honeycomb and combined structure will greatly increase the containment capacity of the fan case. In addition to other possible benefits mentioned, the truss structure 52 described above with respect to FIGS. 5-5a may also provide increased energy absorption during blade containment.

Referring back to FIG. 6, a portion of another example of a fan case 60 is shown, and the relative position of the fan 12 is shown in broken lines for reference. In this example, the fan case 60 comprises an annular metallic shell 61 and an insert 64. The insert 64 in this example is a nano-coated wireframe truss 62 (as shown in FIG. 6a), such as that described above, which is also embedded with an abradable material such as is typically provided in a turbofan engine. The nano truss 62 may be provided as described above, and is then to be coated with the abradable material. Alternately, the nano truss 62 which forms the material of the insert 64 may be incorporated as a separate layer into the fan case 60. Still alternately. the truss/abradable combination may be used as a replacement for a Kevlar wrap external to the fan case.

The nano coating may also reduce weight for so-called soft-wall containment cases. In this example (not depicted), the first (i.e. inner) impact layer of the soft-wall containment case is nano-coated by a hard layer of metal, such as cobalt which has a very high yield strength, so as to bend the released blade. The bent blade requires less area of fabric layers (Kevlar) to be contained. The bent blade tip also reduces the risk of cutting the fabric by the blade's originally sharp corners. Also, the nano coating can control the crack pattern for the inside layer to achieve the most beneficial location for the release blade trajectory.

In another example (not depicted), a fan case isogrid structure includes a nano coating layer applied to the inner surface of the case. The nano coating can be applied to control the pattern of cracks for hybrid containment systems employing isogrid plus Kevlar fabric.

The nano coating may impede a released blade from gouging the inner surface of the fan case during a blade-off event. It would also allow the case to better resist heavy tip rubs by the fan blades in use. It may also be useful to prevent outside cracks from developing by sealing the outside of the fan case. It may also be useful to prevent corrosion of the base material, when provided as a complete encapsulation. The use of a nano coating with a lightweight core may also result in weight savings without loss of performance.

The above description is meant to be exemplary only, and one skilled in the art will recognize that changes may be made to the embodiments described without departing from the scope of the invention disclosed. For example, the containment case (i.e. fan case, compressor case, etc.) may have any suitable configuration, and may also include combinations of the above examples. Any suitable base metal(s), polymer(s) or other material(s) may be used as the substrate material, and any suitable metal and/or metal combinations may be selected for the coating. Any suitable manner of applying the coating layer(s) may be employed. Although fan cases are generally described above, it is to be understood that the construction and configurations of the cases described herein can be used for any case in a gas turbine engine, likely but not necessarily a case which surrounds a rotating fan, compressor or turbine. Still other modifications which fall within the scope of the present invention will be apparent to those skilled in the art, in light of a review of this disclosure, and such modifications are intended to fall within the appended claims.

1. An engine casing for a gas turbine engine, comprising an annular case shell formed of a substrate material, and a nanocrystalline metal coating provided on at least a portion of an inner or outer surface of the annular case shell and extending therearound a circumferential extent.

2. The engine casing of claim 1, wherein the engine casing is mounted to a gas turbine engine about a rotatable bladed rotor.

3. The engine casing of claim 2, wherein the engine casing is a fan casing surrounding a fan of the gas turbine engine.

4. The engine casing of claim 1, wherein the engine casing defines a blade containment zone, the nanocrystalline metal coating being provided at least within the blade containment zone.

5. The engine casing of claim 1, wherein the substrate material is selected from the group consisting of metals, composites, polymers, honeycomb and foam.

6. The engine casing of claim 1, wherein the substrate material of the annular case shell is non-metallic, and the annular case shell is sandwiched by the nanocrystalline metal coating which is disposed on both the inner and the outer surfaces thereof.

7. The engine casing of claim 6, wherein the nanocrystalline metal coating fully encapsulates the non-metallic substrate material of the annular case shell.

8. The engine casing of claim 6, wherein the nanocrystalline metal coating is chemically bonded to the non-metallic substrate material of the annular case shell.

9. The engine casing of claim 6, wherein the substrate material of the annular case shell is a polymer.

10. The engine casing of claim 9, wherein the polymer includes one or more of a poly ether ether ketone (PEEK), a polyamide or a polyimide.

11. The engine casing of claim 6, wherein the substrate material of the non-metallic annular case shell is a carbon-fibre composite.

12. The engine casing of claim 1, wherein the nanocrystalline metal coating a pure metal and is provided as a single layer.

13. The engine casing of claim 12, wherein the pure metal is selected from the group consisting of: Ni, Co, Ag, Al, Au, Cu, Cr, Sn, Fe, Mo, Pt, Ti, W, Zn, and Zr.

14. The engine casing of claim 1, wherein the nanocrystalline metal coating has a non-constant thickness.

15. The engine casing of claim 14, wherein the thickness of the nanocrystalline metal coating is greatest within a blade containment zone region of the engine casing.

16. The engine casing of claim 1, wherein the nanocrystalline metal coating has a thickness between 0.0127 mm and 3.175 mm.

17. The engine casing of claim 1, wherein the nanocrystalline metal has an average grain size of between 10 nm and 500 nm.

18. The engine casing of claim 1, wherein the nanocrystalline metal coating is a plated coating.

19. A gas turbine engine comprising a casing as defined in claim 1.

20. A method of manufacturing an engine casing for a gas turbine engine comprising the steps of: providing an annular case shell formed of a substrate material; and applying a nanocrystalline metal coating over at least a portion of the annular case shell.

21. The method of claim 20, further comprising applying the nanocrystalline metal coating over the entire annular case shell such as to fully envelope said substrate material of the annular case shell.

22. The method of claim 20, wherein the step of providing the annular case shell further comprises forming the annular case shell out of the substrate material, the substrate material being selected from the group consisting of metals, composites and polymers.

23. A method of improving containment capability of a gas turbine engine case comprising applying a nanocrystalline metal coating over at least a portion of a substrate material of an annular case shell, said portion including at least a containment zone surrounding a rotatable bladed rotor of the gas turbine engine.
